(19) United States
(12) Patent Application Publication
(10) Pub. No.: US 2026/0225115 A1
(43) Pub. Date: Aug. 6, 2026

(54) DEVICE FOR GENERATING AT LEAST ONE DROP OF A LIQUID

(71) Applicant: DROPTICAL GMBH, Nümberg (DE)

(72) Inventors: Jonas HEELEIN, Nürnberg (DE); Matthias LEININGER, Feucht (DE); Daniel FÖSTE, Nürnberg (DE)

(21) Appl. No.: 19/150,818

(22) PCT Filed: Jan. 23, 2024
(86) PCT No.: PCT/EP2024/051499

§ 371 Date: Jul. 24, 2025

(30) Foreign Application Priority Data
Jan. 25, 2023 (DE) 10 2023 101 757.8

(51) Int. Cl. B05B 1/08

(52) U.S. Cl. CPC B05B 1/083

(57) ABSTRACT

A device for generating at least one drop of a liquid includes a receiver having a receiving space for receiving a liquid and an outlet opening adjacent to the receiving space. The device further includes an actuator that is activated to generate an impact against a transmission and causes an impact transmission movement of the transmission. The impact is transmitted from the transmission to the receiver by the impact transmission movement to trigger the dispensing of a drop through the outlet opening.

The invention relates to a method for generating at least one drop of a liquid.

Corresponding devices for generating at least one drop of a liquid are known in principle from the prior art. It is known, for example, to act directly on a liquid tank filled with a liquid, by means of actuators or vibration elements, in such a way that a small amount of the liquid emerges from an opening of said liquid tank. A disadvantage in this case is that these systems are limited in terms of their liquid amount of the drop to be generated and/or in terms of their adjustability of the liquid amount of the drop to be generated.

The object of the invention is that of specifying a device which increases the accuracy and/or the possibilities for influencing the variability of the at least one drop of a liquid to be generated, in particular in view of a simple, quick and cost-effective measure.

The object is achieved by a device for generating at least one drop of a liquid according to claim 1. The claims dependent thereon relate to possible embodiments of the device. Furthermore, the object is achieved by a method according to claim 21.

The invention relates to a device for generating at least one drop of a liquid. A device of this kind can be used for example in an industrial plant, in order to apply a defined amount of a liquid in a production process. In general, the device according to the invention can also be referred to as an applicator or liquid dispenser or dispenser. For example, the device is used in production technology and/or in laboratory technology (e.g. in an automatic analyzer) and/or in medical technology, for example in dental technology, for applying drops of liquid. The drops of liquid generated by means of the device can for example have a volume in the range of 25 picolitres to 100 nanoliters, preferably 50 picolitres to 50 nanoliters. The liquid applied by means of the device can comprise an emulsion or a suspension. Alternatively or in addition, a liquid that, in particular during the drop generation and/or at a temperature of 20° C., has a viscosity of at most 100 millipascal seconds (mPa*S), preferably at most 50 millipascal seconds, particularly at most 10 millipascal seconds, most preferably at most 5 millipascal seconds, can be used as the liquid. For example a suspension can be used as the liquid, and/or applied by means of the device.

The device comprises a receiving space for receiving a liquid, comprising a receiving means, wherein the receiving means comprises an outlet opening adjacent to the receiving space. The receiving means comprises a cavity or a receiving space and limits or defines the receiving space with an inner wall. Said inner wall comprises an outlet opening through which a liquid located in the receiving space can emerge to the outside.

The device further comprises an actuator, which optionally comprises a movably mounted striker, which can also be referred to as a plunger. An impact, in particular of the striker, against a transmission means that is movably mounted at least in potions, is or can be generated by activating the actuator. In other words, activating the actuator causes said actuator, in particular its striker, to begin to move and to impact, in particular strike at the end of the movement path, against the transmission means, wherein a strike or an impact on the transmission means is generated as a result. Said strike or impact of the striker against the transmission means leads to the transmission means being caused to move, at least in portions, such that an impact transmission movement of the transmission means, at least in portions, is generated.

The impact received by the transmission means can be transmitted indirectly or directly to the receiving means by the impact transmission movement of the transmission means, such that there is an impact action on the receiving means. Said impact action on the receiving means leads to a triggering of a drop of the liquid through the outlet opening being triggered. Since a transmission means is arranged between the actuator and the receiving means and thus the kinetic energy generated by the actuator is transmitted via the transmission means and its impact transmission movement to the receiving means, it is possible to act purposely on the generation of the drop by the control or influencing or configuration of the impact transmission movement behavior of the transmission means. It is thus possible to influence the amount or the volume and/or the shape of the drop emerging from the outlet opening of the receiving means in a defined and reproducible manner by adjusting and/or changing the point of application of the striker or of the actuator on the transmission means and/or of the point of application of the transmission means on the receiving means. If, in contrast, a direct or instant impact transmission from the actuator or from the striker of the actuator to the receiving means comprising the receiving space and the receiving opening were to occur, the limited accuracy in the controllability of the actuator and its striker would also result in a correspondingly limited design scope for the generation of the drop.

The impact transmission movement of the transmission means can be a movement having linear and/or rotational movement components. Thus, the transmission means can be mounted so as to be, in particular exclusively, linearly movable and/or, in particular exclusively, rotatable relative to the support structure of the device that carries our mounts said transmission means. It is also possible for the transmission means to be mounted in such a way that it performs a rotational or linear movement that is superimposed, for example, by a slotted guide. A pivot pin for a rotatory impact transmission movement of the transmission means can extend inside or outside the geometry of the transmission means. The impact transmission movement of a transmission means that is resilient at least in portions, preferably completely, can for example also comprise a deflection or resilient bending of the transmission means. The transmission means can for example be configured to be resilient in such a way that a strike or impact movement of the actuator or its striker, acting on the transmission means in the form of a linear movement, leads to resilient bending of the transmission means. In other words, the transmission means can be configured to be resilient, in such a way that the transmission means performs resilient bending or a resilient deflection during the impact transmission movement. Thus, the transmission means can for example be mounted in a support structure in such a way that it performs a defined impact transmission movement, in portions, in the form of a deflection or in the form of bending. In this case, the bending of the transmission means can be understood to be its impact transmission movement, which leads to the transmission of the impact or the kinetic energy to the receiving means. In this case, the bending of the transmission means, performed in the course of the impact transmission movement, can comprise a movement out of the main extension plane of the transmission means, in particular bending can take place in such a way that the neutral fiber of the bent transmission means extends along the longitudinal extension of the transmission means or corresponds to the longitudinal central course of the transmission means.

The striker can for example contact or touch the transmission means at a contact portion of the transmission means, which thus functions as an (end) stop for the striker that is set into motion on the actuator side, and in the process sets the transmission means into a movement that occurs at least in portions, wherein this movement is resisted or limited by the receiving means that acts in directly or directly as a movement limitation for the transmission means. An impact induced in the receiving means, in particular in this case, leads to a drop being produced. In this case, the impact transmission movement of the transmission means leads to a movement of the receiving means, such that the walls defining the receiving space perform a movement. Owing to the inertia, the liquid located in the receiving space tends to pause in its original position, and follows the movement of the receiving means only with a delay. This impact-related relative movement of the receiving means with respect to the liquid located therein achieves an output of a small portion of the liquid through the outlet opening or, in other words, a release of the drop of the liquid via the outlet opening.

It is possible that the actuator, in particular a component of the actuator such as a pusher of the actuator or a striker of the actuator, is in contact with the transmission means even when the actuator is not activated. For example, the actuator, in particular a component of the actuator such as a pusher of the actuator or a striker of the actuator, can be in contact with the transmission means both before and during the activation of the actuator. Preferably, the transmission means can have an inner and/or outer preload in the direction of the actuator, such that a gap formation between the actuator and transmission means is largely or completely prevented.

It is possible that the actuator comprises a movably mounted striker, wherein an impact of the striker can be generated by activating the actuator.

In an advantageous embodiment, it may be provided that the actuator is configured as a piezo device or comprises a piezo device. By activation or by energization or by electrical charging of the actuator configured as a piezo device, said actuator performs a lift, wherein said lift indirectly or directly performs an impact on the transmission means. In this case, for example the component of the actuator configured as a piezo device, which directly touches the transmission means, can be considered a movably mounted striker. That is to say that an integral component or a component configured as a separate element, of the actuator configured as a piezo device, which component faces the transmission means, forms a movably mounted striker in that said component is configured to perform a defined movement relative to further integral components or components configured as separate elements, of the actuator. In the case of a multilayer piezo device, individual layers perform a relative movement relative to other layers or are arranged or mounted so as to be correspondingly movable relative to one another.

It is possible that the actuator comprises a lifting means and a pusher, wherein the lifting means reacts actively, electrically, and performs a volume change or a lifting movement, depending on an energization of the actuator, whereas the pusher or striker does not actively perform a volume change or an active lifting movement due to an energization or charging of the actuator, but rather experiences a force application from the lifting means as an element, in particular directly adjacent to the lifting means, and performs a movement as a result of this, which movement is transmitted to the transmission means. For example, the pusher is configured as a rigid body. Thus, the pusher can for example be configured from or comprise metal or ceramic at least in portions, preferably predominantly, particularly preferably completely. The pusher can be arranged or configured at, in particular in or on, the lifting means, for example as a cap, in particular as a ceramic cap. The pusher configured as a cap can cover the lifting means at least at the end face, in particular completely.

The receiving means can for example form a rigid body, which does not experience any elastic deformation in the course of the impulse application or in the course of the impact received by means of the impact transmission movement of the transmission means. The rigidity of the receiving means can be such that it does not experience any deformation i.e. e.g. no elastic or plastic deformation of its walls forming the receiving space, in the course of the impact application of the receiving means, and therefore there is no action, taking place due to a deformation or volume change of the receiving space, on the liquid located in the receiving space, in particular none that would influence drop formation. In other words, the receiving means is configured to be rigid in such a way that it does not experience any deformation of its receiving space in the case of impact application.

In a preferred embodiment, the movement direction of the striker or a lifting direction of the actuator configured as a piezo device during its acceleration can be oriented in parallel with the outlet movement direction of the drop emerging through the outlet opening. Alternatively or in addition, the movement direction of the striker, during the acceleration of the striker or the lifting direction of the actuator configured as a piezo device, can be oriented opposite to an outlet movement direction of the drop emerging through the outlet opening. It is also possible for a movement or a movement axis of the striker relative to a longitudinal axis of the transmission means to enclose an angle in a range of from 20° to 160°, preferably from 45° to 135°, particularly preferably from 65° to 115°, most preferably from 80° to 100°, more preferably of 90°.

It is possible that the receiving means is configured as a rigid body, such that the receiving space formed by the receiving means does not undergo any change in shape during the action of an impact that is transmitted from the transmission means to the receiving means. In this case, a change in shape means in particular that the wall portions of the receiving means that define the receiving space do not lead to bending and/or deformation of said wall portions due to the impact application of the transmission means on the receiving means. At least the transmitted impact does not generate any change in shape of the wall portions of the rigid receiving means forming the receiving space that is in the order of magnitude which would have a substantial influence on the type and/or the scope of the drop triggered from the outlet opening in the course of the impact transmission. This ensures that the generation of the drop is dependent in a targeted and defined manner on the impact application, and not any influences of a deformation of the wall or of the receiving space.

It can prove to be advantageous if a damping means is arranged between the transmission means and the receiving means, such that the impact transmitted from the transmission means to the receiving means is damped. In other words, a damping means is arranged or configured between the receiving means and the transmission means, in an impact transmission chain or in an impact transmission path. A purposeful configuration of the damping means makes it possible to act in a defined manner on the amplitude and/or the temporal behavior of the response of the receiving means to the impact transmitted from the transmission means to the receiving means. For example, the damping means is configured from metal or plastics material, preferably the damping means is configured as a resilient plastics material and/or from synthetic rubber. In a preferred embodiment, the damping means comprises an annular or a circular contact region with the receiving means and/or the transmission means. It is thus possible for the damping means to comprise a recess in which the receiving means is inserted. In this case, in the final assembly state the transmission means and the damping means can surround the receiving means, in particular completely surround a cross-section of the elongate receiving means.

It is possible that a resilient damping element is arranged or configured between an abutment and the transmission means in such a way that during the impact transmission movement of the transmission means the impact transmission movement of the transmission means is acted on in a damping manner, in particular such that a deflection movement of the transmission means is damped during the impact transmission movement of the transmission means. The abutment can for example be formed by a housing body and/or by a structural element of the device. For example, the device comprises a first housing body having a recess, wherein at least one actuator is or can be received in the recess. Optionally, a further housing body can be provided, wherein the transmission means is arranged or configured between the first and the further housing body. Preferably, in this case, a portion of the first housing body and a portion of the further housing body can touch the transmission means. In particular, the transmission means can be held in a clamped manner between a portion of the first housing body and a portion of the further housing body. For example, the first and the further housing body can form a support structure for the transmission means and/or a bearing region of the transmission means.

For example a silicone, in particular a 2-component silicone, can be used as the damping element. The damping element can e.g. have a Shore A hardness of 10 to 30, preferably of 15 to 25, particularly preferably of 20.

In the case of the impact transmission movement or a deflection of the transmission means, the movement is transmitted from the transmission means to the damping element, or the damping element is caused to move at least in portions, wherein this movement of the damping element at least in portions is limited by the abutment and/or a resistance acts, via the abutment, on the movement attempts of the damping element, such that owing to the resilient property of the damping element damping of the impact transmission movement or the deflection of the transmission means takes place.

It is possible that the damping element is or will be formed from a cured casting compound. Preferably, the damping element was introduced into a cavity of the device adjacent to the actuator and/or to the transmission means in a liquid or pasty or bulk material-like form, wherein during or after the introduction of the damping element this has undergone a partial curing or partial hardening, which finally leads to a resilient damping element.

In an optional embodiment, it can be provided that the damping element adjoins at least one closed pressure chamber, wherein during an impact transmission movement of the transmission means the damping element penetrates into the at least one pressure chamber, at least in portions. The movement of the damping element, at least in portions, into the pressure chamber can preferably take place counter to a media volume, in particular gas volume (e.g. air volume), caught or enclosed in the at least one pressure chamber. Owing to the pressure chambers provided for the damping element, the dimensioning of the pressure chambers and/or the geometric configuration of the pressure chambers can specify a defined damping behavior of the damping element during the impact transmission movement of the transmission means in a structurally simple manner. In particular, the position of the at least one pressure chamber relative to the bearing point of the transmission means and/or to the receiving means and/or to the point of application of the actuator on the transmission means can specify or allow for a defined and damping, which is in particular different in a location-dependent manner, of the transmission means during its impact transmission movement.

In principle, it is possible to provide the abutment of the damping element with a rigid abutment structure irrespective of whether or not this forms closed pressure chambers, which rigid structure allows for a different, defined counterhold against the damping element, in a region-dependent manner. For example, a first portion of the abutment structure is at a larger spacing from the transmission means than a second portion of the abutment structure, along the longitudinal course of the transmission means, such that a different resistance behavior of the damping element results depending on the respective portion, and this has an impact, in particular in a region-dependent manner, on the deflection behavior of the transmission means.

The receiving means can for example be configured as a sleeve body. The receiving means preferably has a taper, i.e. a cross-sectional narrowing, at its end facing the outlet opening. In other words, the outlet opening can be configured as a nozzle. The outlet opening of the receiving space can for example be arranged or configured at an end portion of an elongate receiving means. In the case of a receiving means configured as a sleeve body, the outlet opening can be configured at an end of the sleeve. Preferably, a liquid-conducting channel of the receiving means is configured to be straight at least in portions, preferably predominantly, particularly preferably completely.

The receiving means can for example comprise a contact portion which widens radially outwards and is intended for introducing, onto the receiving means, an impact that is generated by means of the striker and is transmitted from the transmission means to the receiving means. For example, the contact portion can be configured and arranged as an uninterrupted or interrupted annular bead on the outside of the receiving means. The contact portion functions as a stop for a force application coming from the transmission means. It is possible for the contact portion to be in direct contact with the damping means, which is arranged in the force transmission or in the movement transmission between the transmission means and the receiving means. The contact portion may be of a shape corresponding to the damping means that touches the contact portion or—if no damping means is interposed—to the transmission means touching the contact portion.

For the structure of the device or for the arrangement of the essential elements of the device, it may prove to be advantageous if a movement axis of the actuator, in particular for performing an impact on the transmission means, and/or a movement axis of the striker, is oriented in parallel with an output movement axis of the drop emerging through the outlet opening. A compact device can be implemented in this way. Preferably, a movement direction of the actuator and/or of the striker for bringing into contact with the transmission means and thus for forming the impact is opposite to a movement direction of the drop emerging from the outlet opening. The outlet movement axis of the drop can be influenced by the shape and orientation of the outlet opening and/or by the movement direction of the impact applied indirectly or directly to the receiving means via the transmission means. Optionally, the movement axis of the actuator (e.g. lifting movement axis), in particular of the striker of the actuator, can enclose an angle with the movement axis of the drop emerging from the outlet opening. Since the actuator, in particular its striker, performs a straight movement and/or the receiving means pushed by the transmission means performs a straight movement, the respective movements can be described by corresponding movement axes, specifically by the movement axis of the actuator and/or of the striker, or by an output movement axis for the drop, which can be substantially influenced by the movement axis of the receiving means.

It is possible for transmission means to comprises a recess in which the receiving means is or can be arranged, at least in portions. Thus, the transmission means can comprise a recess configured as an aperture, in which the receiving means is inserted. In particular, a channel cross-section of the receiving means that guides the liquid from a supply region to the outlet opening is or can be arranged largely, preferably completely, within the recess of the transmission means. In other words, the transmission means can surround the receiving means, at least in portions, with a structure that forms the recess. Preferably, the recess is configured as a recess that forms a closed peripheral edge. Alternatively, the recess can be configured as a recess that has an interrupted peripheral edge. The channel cross-section can for example comprise a region extending transversely to a longitudinal axis of the receiving means.

For example, the transmission means can be configured as a flat body. The transmission means preferably consists of metal, e.g. the transmission means is formed from a metal sheet. The transmission means can for example be configured as a flat body having a substantially and/or an at least largely constant cross-section. The transmission means can for example have an average material thickness or thickness of 0.2 mm to 7 mm, preferably 0.4 mm to 5 mm, particularly preferably 0.6 mm to 4 mm, most preferably 1 mm to 2.5 mm.

The transmission means can for example be mounted or fixed on a support structure of the device via a bearing region of the transmission means, and a contact region of the transmission means, at which the striker and/or the actuator touches the transmission means, is or can be arranged between the bearing region and a transmission region of the transmission means that indirectly or directly transmits the impact to the receiving means. It is thereby possible to achieve that, in the manner of a lever, a movement of the transmission means, induced by the actuator or striker, has a movement that is larger, in a defined manner, at the location of the impact transmission from the transmission means to the receiving means than at the location of the contact of the actuator or striker and transmission means. A targeted design and/or adjustment of the spacing between the contact region, i.e. contact or application point of the actuator or striker and transmission means, and the transmission location—the transmission region—allows for the kinetic energy from the transmission means to the receiving means or optionally damping means arranged on the second receiving means and transmission means, allows for the movement of the receiving means to be specified or adjusted in a defined manner. Therefore, the volume and/or the shape of the drop to be generated can be designed or purposely influenced.

Alternatively, the transmission region of the transmission means for transmitting an impact or motional energy from the transmission means to the receiving means can be arranged between the bearing point of the transmission means on the support structure of the device and the contact region of the transmission means for touching contact of the actuator or striker with the transmission means.

In order to purposely influence the volume and/or the shape of the drop to be triggered, it may be provided that a spacing, in particular a parallel axial spacing, of the movement axis of the actuator or the striker from the output movement axis of the drop emerging through the outlet opening can be changed. Preferably, the movement axis of the actuator or of the striker can be locked, relative to the output movement axis of the drop emerging through the outlet opening, at a first spacing and at at least one second spacing that is different from the first spacing.

Alternatively or in addition it can be provided that a spacing of the movement axis of the actuator or of the striker from a bearing point (bearing region) that mounts or fixes the transmission means with a support structure of the device, and/or a spacing of the movement axis of the receiving means from a bearing region that mounts or fixes the transmission means with the support structure of the device, can be changed, in particular can additionally be locked at different spacings. In this case, a parallel axial spacing exists if the output movement axis of the drop emerging from the outlet opening is oriented in parallel with a movement axis of the actuator or of the striker. Alternatively or in addition, a parallelism of the movement axis of the actuator or of the striker and a longitudinal axis of the receiving means may exist.

The device can comprise a support structure, wherein the actuator and/or the receiving means is/are connected or fastened to the support structure so as to be detachable, in particular detachable without tools. For example, the receiving means is configured as a unit that can be detached from the device. Said unit can for example also comprise a liquid tank and a damping body that connects the liquid tank to the receiving means. Preferably the transmission means is fastened on the support structure, and the receiving means is connected to the transmission means so as to be detachable, in particular detachable without tools. A connection of the receiving means to the transmission means that can be detached without tools makes it possible for a person to be able to remove the receiving means, optionally with further components of the device that form a module or an applicator unit on the receiving means, from the device in a simple and comfortable manner. A detachable connection exists if a detachment can be performed without destruction.

Preferably, an actuator inserted into the device and/or a receiving means inserted into the device can be locked in the inserted state via a locking device. For example, the locking device comprises a handle, in order to perform a locking and/or a detachment of the actuator and/or of the receiving means by a manual force introduction, i.e. a force introduction that takes place by means of manual muscle force. In other words, the locking device can comprise a locking mechanism that can be activated by hand, by means of which a receiving means inserted into the device can be locked in the inserted state. For overcoming the locking, it can be intended for a predefined force to be applied to the handle, in order to allow for detachment of the receiving means from the device. For example, a locking device configured as a locking mechanism comprises a rotatably mounted lever having a handle, wherein the receiving means can be fixed in the device and/or detached by means of a targeted rotational movement of the lever.

The receiving means can for example comprise a guide and/or centering structure, which is configured, during an insertion of the receiving means into a receiving portion of the device, to center and/or to guide the receiving means relative to the support structure of the device, at least in portions. In other words, the guide and/or centering structure allows centering and/or guidance of the supplied receiving means that takes placed in a defined manner and in portions, relative to the support structure of the device. The guide and/or centering structure can be configured as a component of the body forming the receiving means, in particular be configured integrally therewith. Alternatively, the guide and/or centering structure is connected to the body forming the receiving means as a separate component, by means of an integral and/or form-fitting and/or force-fitting connection.

It is possible that the receiving means comprises a fastening structure which is configured to form a force-fitting and/or form-fitting and/or integral connection with a mating fastening structure of the transmission means. Preferably, the fastening and mating fastening structures are configured for example as a bayonet connection. A bayonet closure can allow for simple and reliable connection, in particular taking place manually or in a robot-assisted manner, of the receiving means and transmission means.

The receiving means and the transmission means can for example be connected or connectable to one another exclusively via the fastening and mating fastening structure. The fastening and mating fastening structures are preferably configured such that only at least one defined orientation of the receiving means and transmission means is made possible. For example, only one single predefined orientation of the transmission means and receiving means is made possible, owing to the interaction, in particular of the geometries, of the fastening and mating fastening structures.

It is possible that the receiving means and the transmission means can be or are connected, in particular exclusively, by means of an adhesive connection. Preferably, the receiving means and/or the transmission means can comprise adhesive surfaces on which an adhesive can be arranged, in particular by the manufacturer. Preferably, an adhesive arranged on the receiving means and/or on the transmission means by the manufacturer is protected by a protective layer or protective film arranged by the manufacturer, such that if necessary the protective layer or protective film can be removed and adhesion of the receiving means onto the transmission means can be carried out.

The outlet opening of the receiving means can for example be temporarily displaceable and/or openable by a closure means that is movably mounted relative to the receiving means, in particular so as to be movable on an applicator unit that carries the receiving means. Preferably, a closing movement of the closure means for closing the outlet opening is forcibly coupled to or forcibly controlled with a removal direction of the receiving means out of a receiving portion of the device. A forced coupling or forced control exists e.g. if a mechanism causes a forced movement by contact of the applicator unit receiving the receiving means with a mating contact portion of the mating unit associated with the receiving portion of the device, e.g. an actuator unit. Alternatively or in addition, a release movement of the closure means for releasing the outlet opening can be forcibly coupled to or forcibly controlled with a supply direction of the receiving means into a receiving portion of the device. Optionally, a locking device for locking the receiving means that can be received in the device can be operatively connected to, in particular forcibly controlled with, the closure means and its movement. The closure means can perform a rotational and/or translational movement from a release position to a closure position. Preferably, the closure means can for example perform an exclusively rotational or exclusively linear movement during a displacement from a closure position to a release position and/or from a release position to a closure position. A forcibly controlled connection or a forced control may provide that during the removal of the receiving means from the device or during the detachment of the receiving means from the support structure of the device, proceeding from a locking device actuated in the course of this, closing of the outlet opening of the receiving means by a closure means is performed simultaneously or in a temporally offset manner. It is thus possible to ensure, for example, that when the receiving means is removed no liquid located in the receiving means, e.g. due to shocks during dismantling and/or during further transport of the receiving means, emerges. Alternatively or in addition it can be provided that, upon insertion of the receiving means into the device or into a receiving portion of the device, an actuation of the locking device that locks the insertion causes a release movement of the closure means for releasing the outlet opening to be performed simultaneously thereto or in a manner temporally offset therefrom, in particular temporally in advance. A closure means can also be used on a device that does not provide any locking device for locking the receiving means in the device. Finally, a closure means can also be provided independently of a locking device for locking the receiving means in the device. Preferably, the closure means is connected to the receiving means such that it cannot be detached, i.e. cannot be detached without destruction and/or cannot be detached without tools. This makes it possible to prevent unintended loss of the closure means during transport or mounting of the receiving means.

The striker can for example be mounted on an actuator base structure via at least one guide means. The guide means serves for ensuring a predefined orientation and thus movement of the striker during its movement. Preferably, the striker is mounted on the actuator base structure via at least two guide means, which are in particular arranged on opposite end regions of the striker. The actuator base structure can for example comprise a coil body that can be energized and forms a component of an electromagnet. In this case, a first guide means can be placed on a first side, and a second guide means can be placed on a second side of the coil body, which second side is opposite the first guide means.

The striker can for example be movable back, counter to an actuator-initiated movement direction, by means of at least one return means, or a restoring force can act on the striker from the return means, which force is oriented counter to the actuator-initiated movement direction. The striker can preferably be moved back, via a further return means, in a direction that is opposite to a return-movement direction of the first return means. In other words, the further return means can allow for a restoring force on the striker in a direction which is opposite the direction of the restoring force of the first return means. The striker can for example be brought or be able to be brought into a predefined idle position via the first and the at least one further return means. The striker is preferably acted on, in the idle position, in each case by a preload force from the first and the at least one further return means. Alternatively, the striker is acted on in the idle position exclusively by a restoring force of a return means or by no restoring force of any return means.

In this case, the idle position means a state in which the actuator is not activated. In the case of an actuator configured as an electromagnetic module, this would be present in the idle position if the electromagnetic module is not energized or is energized with a lower current intensity than in the activated state.

The actuator can for example be configured as an electromagnetic module or as an electromagnetic adjusting means. The actuator preferably comprises an electromagnet which can be energized and the magnetic field of which, generated by energization, leads to the movement of the striker arranged in the electromagnet. Alternatively, the actuator can comprise a piezo device, wherein a volume increase or a lift of the piezo device can be performed by energization or electric charging of the piezo device. In this case, the actuation can take place for example in a simple manner, for example it is possible to use a voltage pulse for actuating the actuator and thus for setting the striker into movement or for setting the piezo device into movement. For this purpose, the actuator can comprise e.g. a digital input for receiving the control and/or power signal. For example, a voltage pulse can be used that is in the range of 12 volts to 36 volts. Alternatively or in addition, a control and/or power signal in the form of a voltage pulse having a pulse duration of from 0.1 ms (milliseconds) to 2 ms, preferably from 0.5 ms to 1.5 ms, most preferably from 0.8 ms to 1.2 ms, can be used. The control and/or power signal can for example form an edge-triggered signal, in particular a square-wave signal.

Furthermore, it may prove to be expedient for the guide means and/or the return means to be configured as a spring element. The spring element is preferably configured as a spring under bending load, particularly preferably as a leaf spring. In the present case, a diaphragm spring can optionally also be considered to be a leaf spring, i.e. the leaf spring has a flat structure, wherein a first force, which is supported against a bearing region located in the edge region of the leaf spring, acts on the center thereof, such that it undergoes resilient bending. The flat leaf spring or diaphragm spring can for example comprise recesses which influence its rigidity, e.g. radially and/or helically extending recesses are formed on the flat body, which recesses determine the spring behavior of said body perpendicularly to the main extension plane.

It is possible for a stop damper 48 to be provided, such that the subsequent return movement of the striker, set into motion owing to the activation of the actuator, is limited in a damping manner after the impact or the contact with the transmission means. This quickly decelerates the return movement of the striker, or the striker returns to a standstill quickly, after its return movement, due to the stop damper. In other words, a further oscillation of the striker after its activation is intended to be prevented, in order that a reproducible and/or defined initial situation of the striker, for the next activation, is present as quickly as possible. By quickly reaching a defined basic state before or during the reactivation of the striker is achieved by the stop damper. For this purpose, the stop damper preferably has a high damping effect. It preferably demonstrates viscoelastic behavior. The stop damper can for example consist of plastics material or metal or rubber, or comprise components thereof.

The guide means and the return means can be configured as (a) an integral element or (b) an element assembled from multiple parts. In the case of an integral element, the guide and return means fulfils both functions as an integral body, specifically a return and guidance of the striker.

For example a sealant can be arranged or formed between the receiving means and the actuator, which sealant is configured for separating a first receiving portion of the device for receiving the receiving means in a watertight and/or gastight manner from a further receiving portion of the device for receiving the actuator, in particular the striker of the actuator. Preferably, a first portion of the transmission means is arranged on the side of the sealant facing the first receiving region of the device, and a further portion of the transmission means is arranged on the side of the sealant facing the further receiving region. In other words, the transmission means can penetrate the sealant or a sealing plane defined by the sealant. In this case, the sealant can separate the receiving region of the device for receiving the receiving means with respect to further regions of the device, in particular from the actuator, such that during a removal and/or insertion of a receiving means no liquid and/or dust or other impurities can penetrate into the further regions of the device, in particular into the actuator. It is possible for the sealant to separate two portions of the transmission means from one another, such that a first portion of the transmission means is sealed or separated from a further portion of the transmission means, by the sealant, in a gas-tight and/or liquid-tight manner.

The receiving space of the receiving means can for example be connected in a liquid-conducting manner or fluidically connected to a liquid tank. Preferably, after dispensing of a drop from the outlet opening of the receiving means, liquid can be supplied from the liquid tank into the receiving space of the receiving means. In this case, preferably refilling or re-guidance of the liquid originating from the liquid tank into the receiving space of the receiving means can take place, in particular exclusively, due to gravity and/or, in particular exclusively, due to negative pressure and/or, in particular exclusively, due to excess pressure. For refilling of liquid that is initiated at least partially by excess or negative pressure, a pressure generation means (e.g. a pump or a compressor) can be fluidically connectable to the liquid tank and/or to the receiving means.

For example a damping body can be arranged or configured between the receiving means and the liquid tank, in order to prevent or to damp a transmission of an impact, acting from a transmission means on the receiving means, onto the liquid tank. In other words, there may be a mechanical decoupling or a damped coupling of the liquid tank and receiving means. Thus, in the case of an impact of the striker on the transmission means and the resulting impact transmission from the transmission means to the receiving means, a movement of the receiving means can be performed, without the movement of the receiving means transmitting an impact to the liquid tank of, if an impact transmission occurs, this takes place in a damped manner. Vice versa, this also makes it possible that a movement of the receiving means can take place independently of the liquid tank. The damping body can for example be configured as an annular body or channel body, preferably as a disc-shaped annular body. Thus, the damping body can for example, in particular substantially, be in the shape of a lateral surface of a truncated cone. Alternatively or in addition, the damping body can for example be of a rotationally symmetrical shape. Optionally, the damping body can comprise an, in particular centrally arranged, through-channel, through which a liquid located in the liquid tank can pass and can reach the receiving space of the receiving means. The damping body and/or the receiving means can be configured as a rotationally symmetrical component. A damping body configured having a liquid-guiding channel can for example be configured having its channel central axis coaxial to a channel central axis and/or to a longitudinal axis of the receiving means. The through-channel of the damping body can preferably be configured to be straight, at least in portions, preferably predominantly, particularly preferably entirely.

It is possible that an influencing structure is arranged or configured in the receiving space of the receiving means, in order to achieve influencing of the movement of the liquid relative to the receiving means, which results on account of inertia of the liquid, during action of an impact acting from the transmission means on the receiving means. In other words, the influencing structure functions as a movement inhibitor for a liquid that is located in the receiving space and moved towards the outlet opening or forms a drop at the outlet opening owing to an impact acting on the receiving means. In this way, a targeted design of the influencing structure can cause the shape and/or the amount and/or the temporal output behavior of the drop released from the outlet opening to be set or changed. The influencing structure can for example be configured as an elevation and/or as a recess on a wall that forms the inside wall of the receiving space. For example, the influencing structure is configured as a grating and/or screen body. The influencing structure can comprise a passage surface, in particular a passage cross-sectional surface, through which a liquid that has moved from a liquid tank to an output opening passes. The influencing structure is preferably designed or configured in such a way that is passage surface, in particular its passage cross-section, can be changed. It is possible to move at least one element of the influencing structure that influences the passage surface, in order to change the passage surface, or to change the position and/or orientation of said element in a targeted manner, via an actuator and/or via a manually operable adjusting means. Consequently, it is possible to purposely influence the reaction movement of the liquid located in the receiving space of the receiving means to the impact supplied to the receiving means, and thus set the volume or the amount and/or the shape and/or the temporal course of the generation of the drop by means of the actuator and/or the manually operable adjusting means.

In addition to the device for generating at least one drop of a liquid, the invention also relates to a method for generating at least one drop of a liquid using a device described herein. In particular, a change in the actuation of the actuator and/or of the manually operable adjusting means makes it possible to influence the generation of the drop.

All the advantages, details, embodiments and/or features of the device according to the invention are transferrable or applicable to the method according to the invention, and vice versa.

The invention is explained in more detail with reference to embodiments in the drawings, in which:

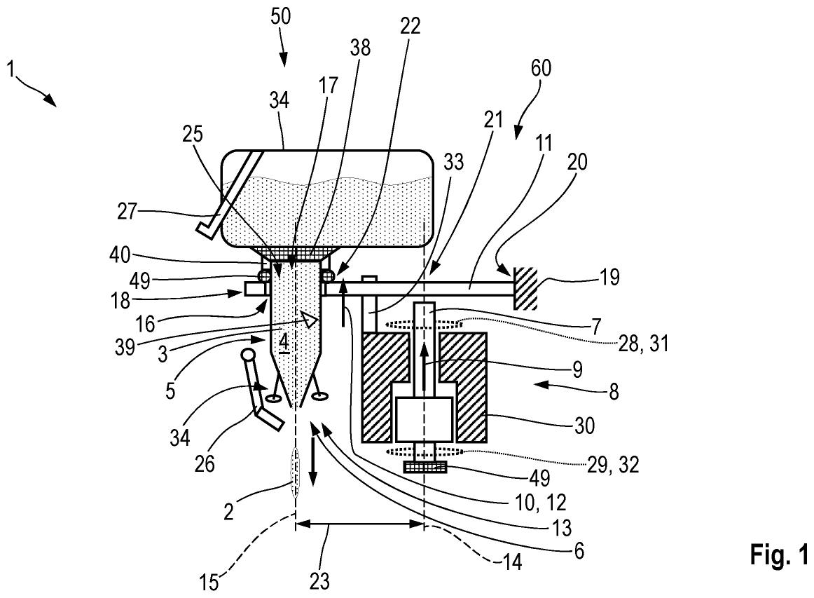

FIG. 1 is a schematic view of a device for generating at least one drop of a liquid according to an embodiment;

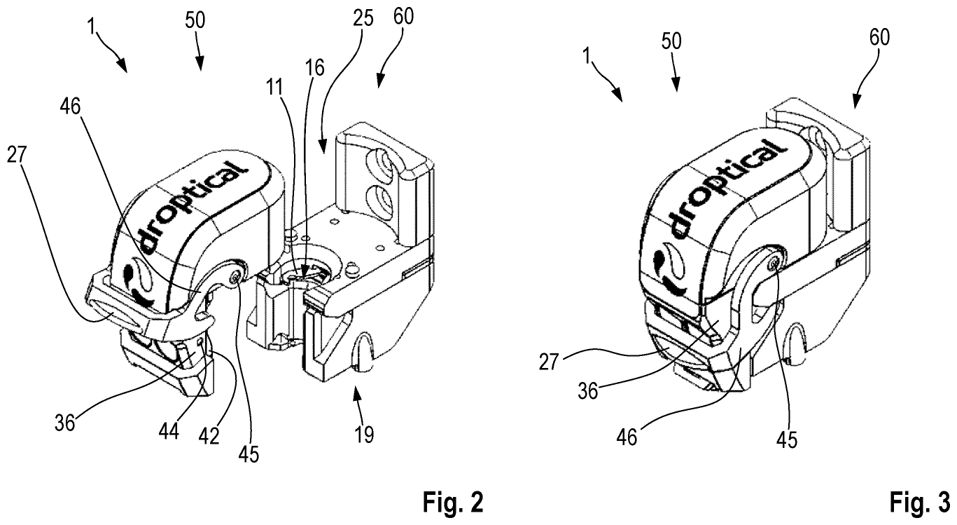

FIG. 2 is a perspective schematic view of a receiving means comprising a first applicator unit, in a state detached from an actuator unit comprising an actuator, according to an embodiment;

FIG. 3 is a perspective schematic view of the applicator unit in a state assembled together with the actuator unit, according to FIG. 2;

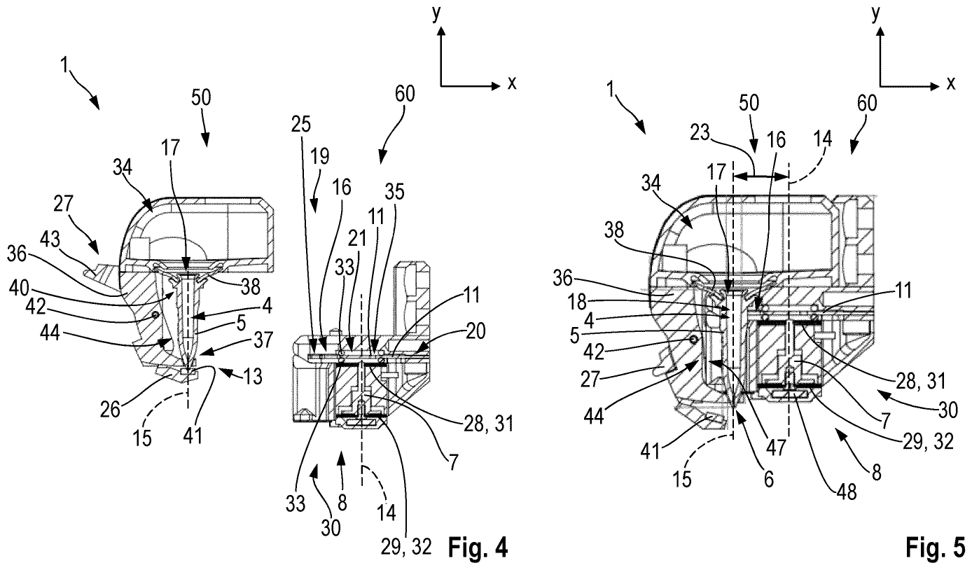

FIG. 4 is a schematic full cross-section of the applicator and actuator unit in their state detached from one another, according to FIG. 2;

FIG. 5 is a schematic full cross-section of the applicator and actuator unit in their assembled state, according to FIG. 3;

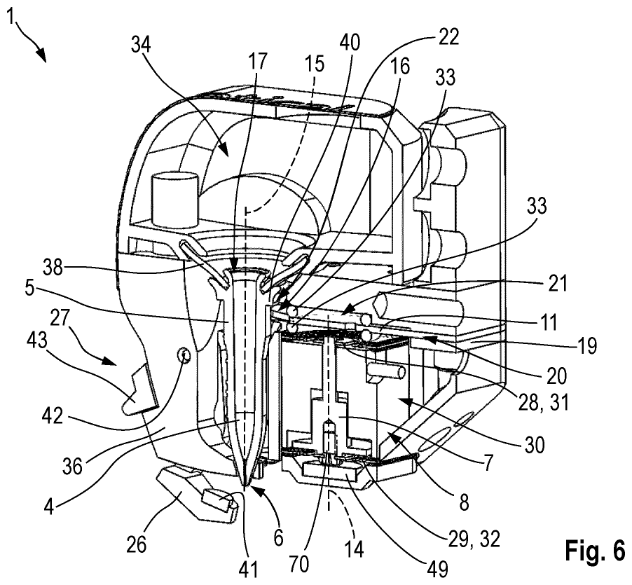

FIG. 6 is a schematic full cross-section of the assembled applicator and actuator unit according to FIG. 5;

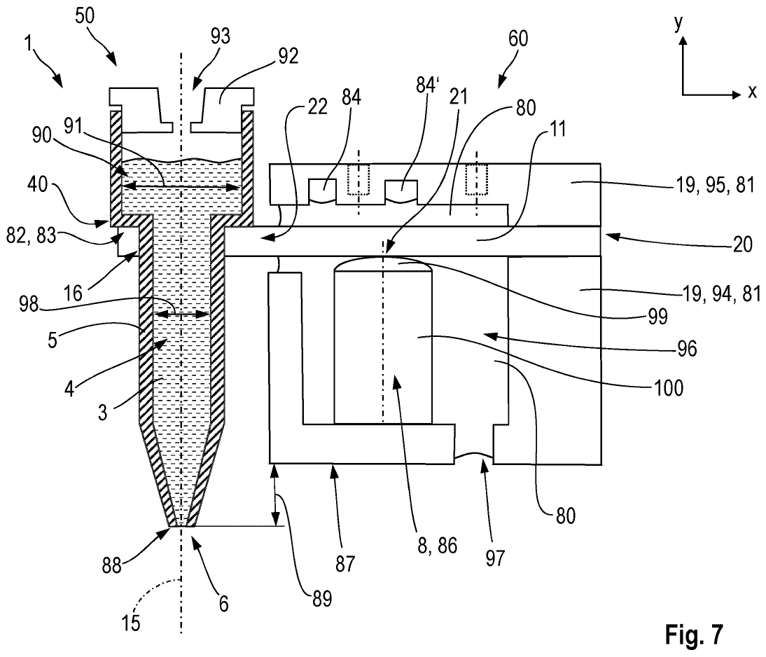

FIG. 7 is a schematic view of an applicator and actuator unit, comprising an actuator unit comprising a piezo device, according to an embodiment, in a discharged state of the piezo device or an idle state of the actuator;

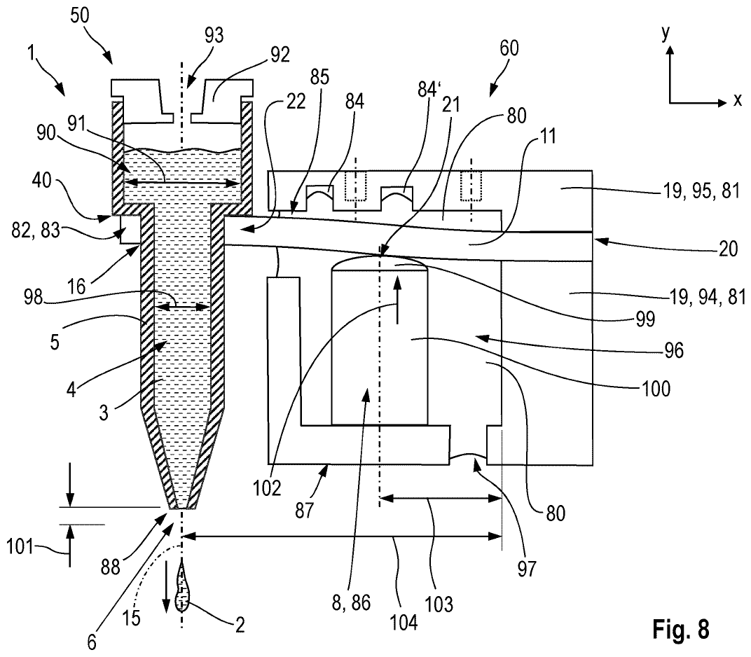

FIG. 8 is a schematic view of an applicator and actuator unit, comprising an actuator comprising a piezo device, according to FIG. 7, in a charged state or in an activated state of the piezo device.

The figures show an embodiment, by way of example, of a device 1 for generating at least one drop 2 of a liquid 3, cf. FIG. 1, wherein the device 1 comprises an applicator unit 50 comprising a receiving means 5, and an actuator unit 60 comprising an actuator 8, and the applicator unit 50 can be assembled together with the actuator unit 60. The receiving means 5 comprises a receiving space 4 for receiving a liquid 3. In this case, the receiving means 5 can be configured as a sleeve, wherein the receiving means 5 has an outlet opening 6 adjacent to the receiving space 4. Furthermore, the device 1 comprises an actuator 8 having a movably mounted striker 7 or a plunger, wherein, by activating the actuator 8, an impact 9 of the striker 7 can be generated against a transmission means 11 which is movably mounted, at least in portions, and leads to an impact transmission movement 12 of the transmission means 11, at least in portions. In an initial position, the striker 7 can be spaced apart from the transmission means 11 or form an air gap. Said spacing can be used as a path for actuator-assisted acceleration of the striker 7, in order to perform a strike or an impact 9 by the striker 7 on the transmission means 11. The impact 9 received by the transmission means 11 is transmitted to the receiving means 5 by the impact transmission movement 12 of the transmission means 11, and leads to an impact 10 against the receiving means 5, in order to trigger the dispensing of a drop 2 through the outlet opening 6. Alternatively, the actuator 8, in particular the striker 7 or a pusher of the actuator 8 can reset on or touch the transmission means 11, without the formation of a gap in the non-activated state of the actuator 8. Thus, an actuator-initiated impact 9 or strike without an acceleration movement of the actuator, in particular of a striker 7 and/or a pusher of the actuator 8, that forms a free space, can be performed. The striker 7 or the pusher of the actuator 8 can for example be configured as a rigid closing body 99 of the lifting means 100, e.g. as a ceramic cap.

In an advantageous embodiment, it may be provided that the actuator 8 is configured as a piezo device 86 or comprises a piezo device 86. For example, a multilayer piezo device can be used. The piezo device 86 can for example have a capacitance of 0.1 to 50 μF, preferably of 0.2 to 35 μF, particularly preferably of 0.3 to 25 μF, more preferably of 0.4 to 15 μF. The piezo device 86 can for example have a stroke length or an effective impact movement of at most 100 μm, preferably of 60 μm, particularly preferably of 50 μm, most preferably of 40 μm, more preferably of 30 μm. Alternatively or in addition, the stroke length of the piezo device can be at least 0.5 μm, preferably 1.0 μm, particularly preferably 2.0 μm, more preferably 3.0 μm.

For a compactly structured device, it may be advantageous if a lower edge 87 of the actuator unit 60 is at a spacing 89 from a lower edge 88 of the applicator unit 50 and/or a lower edge 88 of the outlet opening 6 of the receiving means 5 which is at most 10 mm, preferably at most 8 mm, particularly preferably at most 5 mm. In an advantageous embodiment it may be provided that the lower edge 88 of the applicator unit 60 and/or the lower edge 88 of the outlet opening 6 is arranged or configured in a spacing range of from 5 mm above to 10 mm below, preferably 3 mm above to 8 mm below, particularly preferably 1 mm above to 5 mm below, most preferably 1 mm below to 5 mm below the lower edge 87 of the actuator unit 60.

An inside diameter 98 and/or an inner maximum cross-sectional length of the receiving means 5 can for example be in the range of 1 mm to 10 mm, preferably 1.5 mm to 8 mm, particularly preferably 2 mm to 6 mm, most preferably 2.5 mm to 5 mm.

The receiving means 5 can for example be of a length of from 4 mm to 50 mm, preferably from 7 mm to 40 mm, particularly preferably from 10 mm to 30 mm. It is possible for the receiving means 5 to be configured from plastics material, in particular from polypropylene. For example, the receiving means 5 has been produced in an injection-molding process. As shown by way of example in FIG. 7, the receiving means 5 can comprise an, in particular integral, reservoir 90, which is arranged or configured on the end region of the receiving means 5 facing away from the outlet opening 6. The reservoir 90 can for example have a rotationally symmetrical shape, and/or the reservoir 90 is arranged or configured coaxially to a central portion or a main portion or a nozzle portion of the receiving means 5. For example, an, in particular annular bead-like, contact collar 40 is formed on the outer periphery of the receiving means 5, which collar can be brought into contact with the transmission means 11, cf. FIGS. 7 and 8. Alternatively or in addition, a step-like transition can be formed from the reservoir 90 and a portion of the receiving means 5 adjoining it in the direction of the outlet opening 6, preferably said transition can form a stop or an, in particular annular, contact region between the receiving means 5 and transmission means 11 in the assembled state of the receiving means 5 and transmission means 11. In an optional embodiment, it can be provided that the walls defining the reservoir 90 are formed in one piece, i.e. e.g. of the same material or integrally, with the walls forming the receiving space 5 of the receiving means 5.

The reservoir 90 can for example have an average inside diameter 90 and/or an average inside transverse extension in the range of 5 mm to 30 mm, preferably 6 mm to 25 mm, particularly preferably 7 mm to 20 mm, most preferably 8 mm to 15 mm. Alternatively or in addition, an average inside diameter 90 and/or an average inside transverse extension of the reservoir 90 can be in a ratio of 1.15 to 30, preferably of 1.25 to 20, particularly preferably of 1.5 to 13, most preferably of 1.75 to 10, more preferably of 2 to 5, to an inside diameter 98 and/or to an inner transverse extension of a base portion of the receiving means 5. The base portion is preferably formed by a region of the receiving means 5 that has the largest longitudinal extension, and/or by a region of the receiving means 5 that adjoins the reservoir 90 in the direction towards the outlet opening 6. For example, the base portion has the largest length fraction along the longitudinal axis of the receiving means 5 as a geometrically uniform portion.

It is possible that a closure body 92 is or can be arranged at the end of the receiving means 5, in particular at the end facing away from the outlet opening 6. The closure body 92 can preferably be connectable or connected to the receiving means 5 so as to be detachable or non-detachable. For example, the closure body 92 comprises a pressure-compensation opening 93, such that in the mounted state of the closure body 92 on the receiving means 5, during emergence of a liquid 3 via the outlet opening 6 a pressure compensation for the receiving space 4 of the receiving means 5 can take place via the pressure-compensation opening 92. Owing to the dimensioning of the receiving means 5, the pressure-compensation opening 93 and the outlet opening 6, and in coordination with the flow behavior or the viscosity and/or the density of the liquid 3 to be applied, an outflow of the liquid 3 out of the receiving space 4 can be prevented in the idle state of the device 1 and/or of the receiving means 5. It is possible to configure an interface structure at, in particular in or on, the closure body 92 for connection to a suction device (not shown). A negative pressure is generated in the receiving space 4 by means of the suction device that is or can be connected to the pressure-compensation opening 93. In particular, generating the negative pressure in the receiving space 4 makes it possible for a fluid to be suctioned into the receiving space 4 via the outlet opening 6. For this purpose, the outlet opening 6 can protruded or be immersed into a container filled with a fluid. The suction device can generate a negative pressure by means of a motor or by means of muscle power. For example, the suction device is configured as a syringe, in particular as a plunger syringe, wherein an, in particular standardized, output end of the suction device, e.g. a nozzle, can correspond to the interface structure of the closure body. Thus, the interface structure of the closure body can be configured for example in the manner of a Luer system (e.g. as a Luer slip or as a Luer lock) and therefore allow for force-fitting and/or form-fitting connection of a syringe provided with a Luer system to the closure body 92.

In this case, the receiving means 5 is for example configured as a rigid body, such that the receiving space 4 formed by the receiving means 5 does not undergo any change in shape during an action of an impact 10 that is transmitted from the transmission means 11 to the receiving means 5. Thus, the receiving means 5 and its inner wall that defines or forms the receiving space 4 performs a movement relative to the liquid 3 located in the receiving space 4, such that owing to the pausing or the inertia of the liquid 3 with respect to the movement of the receiving means 5, a drop 2 detaching out of the outlet opening 6 forms in response to the impact 9, 10.

Preferably a damping means 49 is arranged between the transmission means 11 and the receiving means 5, such that the impact 10 transmitted from the transmission means 11 to the receiving means 5 is damped. The damping means 49 is configured as an, in particular single, means that receives the impact from the receiving means 5 and transmits it to the receiving means 5. In the embodiment shown in the figures, the damping means 49 is configured as an elastomer ring. The sleeve-shaped receiving means 5 can for example comprise a radially outwardly pointing or a radially outwardly protruding contact portion, e.g. a contact collar 40, on which the damping means 49 comes directly or the transmission means 5 comes directly to rest or in contact during the contact for transmitting the impact 10. The contact collar 40 can for example be configured as an annular bead.

It is possible that a resilient damping element 80 is arranged or configured between an abutment 81 and the transmission means 11 in such a way that during the impact transmission movement 12 of the transmission means 11 the impact transmission movement 12 of the transmission means 11 is acted on in a damping manner. Thus, for example a deflection movement 85 of the transmission means 11 can be damped. The abutment 81 can for example be formed by a housing body 94, 95 and/or by a structural element of the device 1. For example, the device 1 comprises a first housing body 94 having a recess 96, wherein at least one actuator 8 is or can be received in the recess 96. Optionally, a further housing body 95 can be provided, wherein the transmission means 11 is arranged or configured between the first and the further housing body 94, 95. Preferably, in this case, a portion of the first housing body 94 and a portion of the further housing body 95 can touch the transmission means 11, in particular receive or hold it between them. For example, the first and the further housing body 94, 95 can form a support structure 19 for the transmission means 11 and/or a bearing region 20 of the transmission means 11.

It is possible that the damping element 80 is or will be formed from a cured or curing casting compound. Preferably, the damping element 80 was introduced into a cavity of the device 1, in particular at least one housing body 94, 95, adjacent to the actuator 8 and/or to the transmission means 11 in a liquid or pasty or bulk material-like form, wherein during or after the introduction of the damping element 80 this has undergone or undergoes a partial curing or partial hardening, which finally leads to a resilient damping element 80. It is possible that at least one housing body 9495 comprises an introduction opening 97 which serves, during the production method, to introduce the liquid or pasty or bulk material-like damping element 80 into a cavity of at least one housing body 94, 95, in particular into a recess of at least one housing body 94, 95 that receives the actuator 8 and/or the transmission means 11 at least in portions.

An optionally production method can for example take place in that first an actuator 8 is inserted, in particular fixed, in a recess 96 of the first housing body 94. Then, the transmission means 11 is set, in particular fixed, between the first housing body 94 and a set-on second housing body 95. Then, the introduction of a liquid or pasty or bulk material-like (e.g. powdered) damping material for forming a damping element 80 takes place via an introduction opening 97. In this case, the introduction opening 97 can be on at least one housing body 94, 95 and/or on a gap which is formed by a housing body 94, 95 and the transmission means 11 or by at least two housing bodies 94, 95. Preferably, the damping material that is introduced into the recess 96 and forms the damping element 80 touches the actuator 8 and/or the transmission means 11 at least in portions, preferably predominantly.

In an optional embodiment, it can be provided that the damping element 80 adjoins at least one closed pressure chamber 84, 84′, wherein during an impact transmission movement 12 of the transmission means 11 the damping element 80 penetrates or protrudes, preferably temporarily, into the at least one pressure chamber 84, 84′, at least in portions. The movement of the damping element 80, at least in portions, into the at least one pressure chamber 84, 84′ can preferably take place counter to a media volume, in particular gas volume (e.g. air volume), caught or enclosed in the at least one pressure chamber 84, 84′. Owing to the pressure chambers 84, 84′ provided for the damping element 80, the dimensioning of the pressure chambers 84, 84′ and/or the geometric configuration of the pressure chambers 84, 84′ can specify a defined damping behavior of the damping element 80 during the impact transmission movement 12 of the transmission means 11 in a structurally simple manner. In particular, the location of the at least one pressure chamber 84, 84′ relative to the bearing point of the transmission means 11 and/or to the receiving means 5 and/or to the point of application of the actuator 8 on the transmission means 11 can specify or allow for a defined damping, which is in particular different in a location-dependent manner, of the transmission means 11 during its impact transmission movement 12.

In the embodiment shown, the receiving means 5 is configured as a rigid sleeve body, wherein said receiving means tapers or forms a nozzle at the end 13 of the receiving means 5 facing the outlet opening 6. A movement axis 14 of the actuator 8, in particular for performing an impact on the transmission means 11, and/or of the striker 7 can—as shown—be oriented in parallel with an output movement axis 15 of the drop 2 emerging through the outlet opening 6, wherein this arrangement of the striker 7 or the pusher of the actuator 8 and the receiving means 5 side-by-side achieves a compact design.

The transmission means 11 can for example comprises a recess 16 in which the receiving means 5 is or can be arranged, at least in portions. FIG. 2 shows a recess 16 that is configured in a claw-like manner or has the shape of an open jaw, and into which the receiving means 5 is inserted. In this case, a channel cross-section 18 of the receiving means 5 which guides the liquid 3 from a supply region 17 to the outlet opening 6, is or can be arranged largely (see FIG. 2) or completely (see FIG. 1) inside the recess 16 of the transmission means 11 or is largely (see FIG. 2) or completely (see FIG. 1) surrounded by the structure of the transmission means 11 that forms the recess 16.

The transmission means 11 is mounted on a support structure 19 of the device 1 via a bearing region 20 of the transmission means 11, wherein a contact region 21 of the transmission means 11, at which the actuator 8 and/or the striker 7 touches the transmission means 11, is or can be arranged between the bearing region 20 and a transmission region 22 of the transmission means 11 that indirectly or directly transmits the impact 9 to the receiving means 5. Thus, the contact region 21 is arranged between the bearing region 20 and the transmission region 22.

TO HERE

[symbol]

A spacing 23, in particular a parallel axial spacing, of a movement axis 14 of the actuator 8, in particular the striker 7 thereof, from an output movement axis 15 of the drop 2 emerging through the outlet opening 6 and/or from a longitudinal axis of the sleeve-shaped receiving means 5 can be variable. For this purpose, an adjustment device (not shown) can be provided, which allows for manual or automatic adjustment of the spacing 23 between the movement axis 14 and output movement axis 15 and/or longitudinal axis of the sleeve-shaped receiving means 5.

The actuator 8 and/or the receiving means 5 can be connected to the support structure 19 of the device 1 so as to be detachable, in particular detachable without tools. Preferably the transmission means 11 is fastened on the support structure 19, in particular such that it cannot be detached without tools, and the receiving means 5 is detachably connected to the transmission means 11, in particular so as to be detachable without tools. In this way, a device 1 can be achieved which allows for a simple replacement of the receiving means 5 on a support structure 19 that comprises or carries the actuator 8 and in particular additionally the transmission means 11. In this way, an applicator unit 50 can also be connectable to the actuator unit 60 detachably, in particular such that it can be detached without tools, wherein in this case the actuator unit 60 can form the support structure 19 of the device 1.

It is possible to provide a device 1 that is structurally compact, easy to actuate, and the receiving means 5 of which, preferably together with the liquid tank 34, are easy to detach from the actuator unit 60 that comprises the actuator 8 and preferably likewise the transmission means 11. Thus, a replacement of the receiving means 5 and an applicator unit 50 comprising a liquid tank 34, on the actuator unit 60, is possible in a simple and comfortable manner. It is thus possible that an arrangement comprises at least one actuator unit 60 and at least two applicator units 50, wherein the applicator units 50 can be alternately assembled with the actuator unit 60. For example, the liquid tanks 34 of at least two applicator units 50 are filled with different liquids, such that if required the applicator unit 50 can be used of which the liquid is intended to be used for generating a drop.

The receiving means 5 can comprise a—cf. FIG. 1—guide and/or centering structure 24, which is configured, during insertion of the receiving means 5 into a receiving portion 25 of the device 1, to center and/or to guide the receiving means 5 relative to the support structure 19 of the device 1, at least in portions. Preferably at least part of the guide and/or centering structure 24 is arranged or configured in the close vicinity of the end 13 of the receiving means 5 that faces the outlet opening 6. The guide and/or centering structure 24 allows for comfortable mounting of the receiving means 5 in the support structure 19 of the device 1, and in particular during the supply movement of the receiving means 5 deflects or guides this into a predefined position and/or orientation. The guide and/or centering structure 24 can for example comprise mutually corresponding surfaces and/or points, in particular glide slopes, on the receiving means 5 and the support structure 19.

In an advantageous embodiment, it can be provided that the receiving means 5 comprises a fastening structure 82 which is configured to form a force-fitting and/or form-fitting and/or integral connection with a mating fastening structure 83 of the transmission means 11. For example, the fastening and mating fastening structures 82, 83 are configured as a bayonet connection. Optionally, the receiving means 5 and transmission means 11 are or can be interconnected exclusively via the fastening and mating fastening structure. According thereto, the receiving means 5 can for example be carried inside the device 1 exclusively via the transmission means 11. The fastening and mating fastening structures 82, 83 are preferably configured such that only defined orientations of the receiving means 5 and transmission means 11 are made possible. For example, only one single predefined orientation of the transmission means 5 and receiving means 11 is made possible, owing to the interaction, in particular of the geometries, of the fastening and mating fastening structures 82, 83.

The receiving means 5 and the transmission means 11 can be or are for example connected, in particular exclusively, by means of an adhesive connection.

Optionally, the outlet opening 6 of the receiving means 5 can be closable by a closure means 26 that is movably mounted on the applicator unit 50 that comprises the receiving means 5. Preferably, a closing movement of the closure means 26 for closing the outlet opening 6 is forcibly controlled, i.e. can be performed in the course of a controlled movement, with a removal movement of the receiving means 5 out of the receiving portion 25 of the device 1, and/or a release movement of the closure means 26 for releasing the outlet opening 6 is forcibly controlled with a supply movement of the receiving means 5 into the receiving portion 25 of the device 1.

Alternatively or in addition, the release and/or closing movement of the closure means 26 can be dependent on a locking device 27 that locks the receiving means 5 in the receiving portion 25 of the device 1, in particular forced control exists between the release and/or closing movement and the state of the locking device. According to the embodiment shown in FIG. 4 to 6, the closure means 26 is provided with a resilient sealing element 41, which closes the outlet opening 6 in the closed position, cf. FIG. 4. In this case, the closure means 26 is configured as a lever which is rotatably mounted about a pivot pin 42, wherein the lever comprises a contact portion 44 between its pivot pin 42 and the sealing element 41. During the insertion of the applicator unit 50 into or onto the actuator unit 60, a mating contact portion 47 of the actuator unit 60 comes into contact with the contact portion 44 and leads to a displacement of the closure means 26 into the release position that releases the outlet opening 6. The closure means 26 can be preloaded into the closed position, closing the outlet opening 6, by a preloading means (not shown), such that when the applicator unit 50 is removed from the actuator unit 60, on account of the contact portion 44 and the mating contact portion 47 being brought out of contact, and on account of the preload force of the preloading means, the closure means 26 is moved into the closed position.

Furthermore, the applicator unit 50 or the actuator unit 60 can comprise a lever 46 that is rotatably mounted an axis of rotation 45, wherein the lever comprises a handle 43, by means of which the lever 46 can be moved by a person in order to bring a lever-side engagement element 48 into engagement in an actuator-side mating element 49. Thus, a locking of the applicator unit 50 and actuator unit 60 can be formed by a locking device 27 configured as a rotatable lever 46. Alternatively, the locking device 27 can comprise a closing means that is movable exclusively linearly or both linearly and rotatably.

The striker 7 is mounted on an actuator base structure 30 via at least one guide means 28. In the embodiment shown, the striker 7 is mounted on the actuator base structure 30 is two guide means 28, 29, which are in particular arranged on opposite end regions of the striker 7.

The striker 7 can for example be movable back or moved back, counter to an actuator-initiated movement direction, by means of at least one return means 31. Furthermore, the striker 7 can be moved back, via a further return means 32, in a direction that is opposite to a return-movement direction of the first return means 31. In the embodiment shown in the figures, the return function and the guide function with regard to the striker 7, for the movement thereof relative to the actuator base structure 30, is implemented by two guide and return means 28, 29, 31, 32 that each include both functions. Said guide and/or return means 28, 29, 31, 32 are for example configured as a spring element; preferably, the spring element is configured as a spring under bending load, particularly preferably as a leaf spring. In particular at least one, in particular both, guide and return means 28, 29, 31, 32 can be configured as disc springs or as diaphragm springs, as a result of which a small structural height in the Y-direction can be achieved, cf. FIGS. 4 and 5.

Alternatively or in addition to at least one return means 31, 32, in particular in addition to at least two return means 31, 32, a stop damper 48 can be provided. Said stop damper 48 is preferably arranged on the side of the striker 7 facing away from the transmission means 11, and acts in a damping manner on a return movement of the striker after this has touched the transmission means 11. For this purpose, the stop damper 48 can preferably serve as an end length limitation for the striker 7 that is moving back. In other words, a further oscillation of the striker 7 after its activation is intended to be prevented or at least kept as short as possible, in order that a reproducible and/or defined initial situation of the striker 7, for the next activation, is present as quickly as possible.

It is possible that the striker 7 and/or the stop damper 48 is equipped with an adjustment means 70, by means of which the maximum movement path of the striker 7, in particular between the stop damper 48 as an end stop on one side and the transmission means 11 and an end stop on the other side, can be adjusted or is adjustable. For this purpose, for example the adjustment means 70 can be arranged or configured in or on a cover for closing the receiving region of the actuator base structure for receiving the striker 7. Alternatively, the adjustment means 70 can be arranged or configured in an adjustably mounted manner on the actuator base structure 30 itself.

The adjustment means 70 can be fastened e.g. in a screwable manner to a structure that receives it. For example, the adjustment means 70 is configured as a screw, in particular as a setscrew. For example, the adjustment means 70 is configured as a screw and is arranged in a screw receiving recess of the striker 7, cf. FIG. 6.

Optionally—as shown in FIG. 1—a sealant 33 can be arranged or formed between the receiving means 5 and the actuator 8, which sealant is configured for separating a first receiving portion 25 of the device 1 for receiving the receiving means 5 in a watertight and/or gastight manner from a further receiving portion 35 of the device 1 for receiving the striker 7. Preferably, a first portion of the transmission means 11 is arranged on the side of the sealant 33 facing the first receiving portion 25 of the device 1, and a further portion of the transmission means 11 is arranged on the side of the sealant 33 facing the further receiving portion 35.

In the embodiment shown in FIG. 6, the sealant 33 comprises at least one sealing ring, in particular at least one O-ring. For example, in each case a part of the sealant 33, e.g. in each case an O-seal, is arranged on the upper side and underside of the transmission means 11.

The receiving space 4 of the receiving means 5 can for example be connected to a liquid tank 34 in a liquid-conducting manner. In particular, after a drop 2 has emerged from the outlet opening 6 of the receiving means 5, liquid 3 can be supplied from the liquid tank 34 into the receiving space 4 of the receiving means 5 due to gravity and/or due to negative pressure and/or due to excess pressure. A damping body 38 can be arranged or configured between the receiving means 5 and the liquid tank 34, in order to prevent or to damp a transmission of an impact 10, acting from the transmission means 11 on the receiving means 5, onto the liquid tank 34. As shown for example in FIG. 4, the damping body 38 can be configured as a rotationally symmetrical body. In particular, the receiving means 5 is connected in a supporting manner to the body forming the liquid tank 34, in particular exclusively, via the damping body 38.

Furthermore, it is optionally possible for the applicator unit 50 comprising the receiving means 5 to comprise a holding arm 36 for detachably holding the receiving means 5 on the applicator unit 50. For example, the holding arm 36 can comprise an insertion recess 37 in which the receiving means 5 plunges or is or can be inserted, at least in portions, such that the receiving means 5 is caught inside a space formed by the damping body 38 and the insertion recess 37 of the holding arm 36.

For example, an influencing structure 39 can be arranged or configured in the receiving space 4 of the receiving means 5, in order to achieve influencing of the movement of the liquid 3 relative to the receiving means 5, which results on account of inertia of the liquid 3, during action of an impact 10 acting from the transmission means 11 on the receiving means 5. Thus, for example, an influencing structure 39 in the form of a movably mounted fluid deflection element can be arranged in the receiving space 4, and the volume and/or the amount and/or the temporal course of the drop output and/or the shape of the drop 2 can be influenced or changed depending on the position and/or orientation of said fluid deflection element.

Furthermore, the invention includes a method for generating at least one drop 2 of a liquid 3 using a device 1 described herein.

The device 1 can for example be configured in such a way that a lift 101 of the receiving means 5 at its outlet opening 6, generated by the activation of the actuator 8, is performed in the range of 1 mm to 120 mm, preferably from 3 mm to 90 mm, more preferably from 5 mm to 60 mm, most preferably from 6 mm to 40 mm.

A lift 102 or a maximum effective impact extent of the actuator 8 can for example be in the range of 0.5 mm to 60 mm, preferably of 1 mm to 50 mm, more preferably of 2 mm to 40 mm, most preferably of 3 mm to 30 mm.

Optionally, a lever ratio proceeding from a bearing region 20 that fixes the transmission means 5, from which the transmission means 5 experiences a deflection, e.g. a bending, owing to the activation of the actuator 8, to the contact region 21 at which the actuator 8 touches the transmission means 5, and to an outlet opening 6 of the receiving means 5 or to an output longitudinal axis (output movement axis 15) of the receiving means 5 extending through the outlet opening 6, can be in a range of 1.1 to 5, preferably 1.2 to 4, particularly preferably 1.3 to 3, most preferably 1.5 to 2.5. In other words, the lever ratio relates to the ratio of the lengths 103, 104 between the bearing region 20 and the contact region 21 (length 103) and between the bearing region 20 and an outlet opening 6 (length 104), wherein the two lengths 103, 104 are taken from or correspond to a projection of the spacings in a plane extending in parallel with the main extension plane of the transmission means 5.

### LIST OF REFERENCE SIGNS

1 device
2 drop of 3
3 liquid
4 receiving space of 5
5 receiving means
6 outlet opening of 5
7 striker
8 actuator
9 impact of 8 on 11
10 impact of 11 on 5 or of 11 on 49 and of 49 on 5
11 transmission means
12 impact transmission movement of 11
13 end of 5
14 movement axis of 7
15 output movement axis of 2
16 recess of 11
17 supply region of 5
18 channel cross-section of 5
19 support structure of 1
20 bearing region of 11
21 contact region of 11
22 transmission region of 11
23 spacing between 14 and 15
24 guide and/or centering structure
25 receiving portion of 1
26 closure means
27 locking device
28 first guide means
29 second guide means
30 actuator base structure
31 first return means
32 second return means
33 sealant
34 liquid tank
35 further receiving portion
36 holding arm of 50
37 insertion recess of 36
38 damping body
39 influencing structure
40 contact collar
41 sealing element of 26
42 pivot pin of 26
43 handle of 27
44 contact structure of 26
45 axis of rotation of 46
46 lever of 27
47 mating contact portion
48 stop damper
49 damping means
50 applicator unit
60 actuator unit
70 adjustment means
80 damping element
81 abutment
82 fastening structure of 5
83 mating fastening structure of 11
84, 84′ pressure chamber (84, 84′)
85 deflection movement of 11
86 piezo device
87 lower edge of 60
88 lower edge of 50 or 6
89 spacing between 87 and 88
90 reservoir of 5
91 inside diameter of 90
92 closure body
93 pressure-compensation opening of 92
94 first housing body
95 further housing body
96 recess of 94
97 introduction opening
98 inside diameter
99 closing body
100 lifting means of 8
101 lift of 6
102 lift of 8
103 length between 20 and 21
104 length between 20 and 6

1. A device for generating at least one drop of a liquid, comprising:
a receiving means, comprising a receiving space for receiving a liquid, wherein the receiving means has an outlet opening adjacent to the receiving space,
an actuator, wherein, by activating the actuator, an impact can be generated against a transmission means which is movably mounted, at least in portions, and leads to an impact transmission movement of the transmission means, at least in portions, and
the impact received by the transmission means can be transmitted to the receiving means by the impact transmission movement of the transmission means, in order to trigger the dispensing of a drop through the outlet opening.

2. The device according to claim 1, wherein the actuator comprises a movably mounted striker, wherein an impact of the striker can be generated by activating the actuator.

3. The device according to either claim 1, wherein the actuator is configured as a piezo device or comprises a piezo device.

4. The device according to claim 1, wherein the receiving means is configured as a rigid body, such that the receiving space formed by the receiving means does not undergo any change in shape during an action of an impact that is transmitted from the transmission means to the receiving means.

5. The device according to claim 1, wherein a damping means is arranged between the transmission means and the receiving means, such that the impact transmitted from the transmission means to the receiving means is damped.

6. The device according to claim 1, wherein a resilient damping element is arranged or configured between an abutment and the transmission means in such a way that during the impact transmission movement of the transmission means the impact transmission movement of the transmission means is acted on in a damping manner.

7. The device according to claim 6, wherein the damping element is formed from a cured casting compound.

8. The device according to claim 6, wherein the damping element adjoins at least one closed pressure chamber, wherein during an impact transmission movement of the transmission means the damping element penetrates into the at least one pressure chamber, at least in portions.

9. The device according to claim 1, wherein the receiving means is configured as a sleeve body.

10. The device according to claim 1, wherein a movement axis of the actuator, and/or a movement axis of the striker, is oriented in parallel with an output movement axis of the drop emerging through the outlet opening.

11. The device according to claim 1, wherein the transmission means comprises a recess in which the receiving means is or can be arranged, at least in portions.

12. The device according to claim 1, wherein the transmission means is mounted on a support structure of the device via a bearing region of the transmission means, and a contact region of the transmission means, at which the striker and/or the actuator touches the transmission means, is or can be arranged between the bearing region and a transmission region of the transmission means that indirectly or directly transmits the impact to the receiving means.

13. The device according to claim 1, wherein the device comprises a support structure, wherein the actuator and/or the receiving means is/are or can be connected to the support structure detachably.

14. The device according to claim 1, wherein the receiving means comprises a fastening structure which is configured to form a force-fitting and/or form-fitting and/or integral connection with a mating fastening structure of the transmission means.

15. The device according to claim 10, wherein the receiving means and the transmission means can be or are connected, in particular exclusively, by means of an adhesive connection.

16. The device according to claim 1, wherein the outlet opening of the receiving means can be closed by a closure means that is mounted so as to be movable relative to the receiving means.

17. The device according to claim 1, wherein a sealant is arranged or formed between the receiving means and the actuator, which sealant is configured for separating a first receiving portion of the device for receiving the receiving means in a watertight and/or gastight manner from a further receiving portion of the device for receiving the actuator.

18. The device according to claim 1, wherein the receiving space of the receiving means is connected in a liquid-conducting manner to a liquid tank, in particular after a drop has emerged from the outlet opening of the receiving means liquid can be supplied from the liquid tank into the receiving space of the receiving means.

19. The device according to claim 18, wherein a damping body is arranged or configured between the receiving means and the liquid tank, in order to prevent or to damp a transmission of an impact, acting from the transmission means on the receiving means, onto the liquid tank.

20. The device according to claim 1, wherein the transmission means is configured in a resilient manner, such that the transmission means performs resilient bending during the impact transmission movement.

21. A method for generating at least one drop of a liquid using a device according to claim 1.
